(19) United States
(12) Patent Application Publication
(10) Pub. No.: US 2020/0405581 A1
(43) Pub. Date: Dec. 31, 2020

(54) DISPOSABLE CONTAINER WITH SPECIALIZED DISPENSING MEANS

(71) Applicant: Benjamin Paulus, Kirkland, WA (US)

(72) Inventor: Benjamin Paulus, Kirkland, WA (US)

(21) Appl. No.: 16/457,182

(22) Filed: Jun. 28, 2019

(51) Int. Cl. A61J 11/04; A61J 9/08

(52) U.S. Cl. CPC A61J 11/04; A61J 11/008; A61J 9/085

(57) ABSTRACT

Disclosed is a disposable container that includes a body portion, a sealing collar, a nozzle, and a sealing disc. The body portion is having a threaded neck formed from the body portion. In an aspect, the body portion is made of a laminated material. The sealing collar adapted to detachably attached with the body portion. The nozzle is removably fixed to the body portion with the sealing collar adapted to be screwed on to the threaded neck. The sealing disc disposed between the sealing collar and the nozzle to stop the flow of a beverage to the nozzle.

### TECHNICAL FIELD

The present invention relates to a container for liquids, in particular to a disposable liquid container incorporating specialized dispensing nozzles.

### BACKGROUND

Pre-filled, sealed, disposable beverage containers provide significant convenience to consumers by allowing them to readily purchase, transport, and consume a pre-formulated beverage. More generally, pre-formulated beverages or solutions can provide significant convenience to consumers. For example, pre-formulated saline solutions provide consumers with access to a sanitary cleansing solution while eliminating the need for a consumer to formulate the solution themselves. Often, the pre-formulated solutions are specialized to an extent that they require specialized dispensing means. For example, baby formula is best-dispensed via a soft nipple, sterile cleansing solution may be best dispensed through a nozzle adapted for spraying a precise jet of liquid, and a sports or protein drink may be best dispensed through a resealable snap-type cap.

Currently, if a consumer wished to dispense a beverage or fluid using a specialized dispensing means, the consumer is required to obtain a specialized dispenser, fill it with fluid, and then dispense it.

In order for a consumer to readily transport a pre-formulated fluid that requires specialized dispensing, the consumer would need to bring both a container of fluid, as well as the specialized dispenser. While certain pre-filled beverage dispensers are available, previously disclosed dispensing containers are unnecessarily complex and material intensive.

Many specialized fluid-dispenser combinations are best-operated when a user is able to apply pressure to a container in a way that generates a positive pressure for expelling the fluid through the specialized nozzle. As such, highly flexible containers are beneficial to this end, as overly rigid containers tend to counteract applied pressure during such a process.

Furthermore, specialized dispensing nozzles may tend to be either mechanically delicate and/or must be maintained in a sterile state. As such, a pre-filled disposable container equipped with a specialized nozzle is best-distributed with the nozzle in a protected/sterile state.

US patent application number 20070084819 A1 filed by Fialkowski; Edward B. discloses a pre-filled, disposable, and sterile infant beverage container. The infant beverage container disclosed in Fialkowski; Edward B. reference includes a disposable bottle, generally a thin-walled bottle, and a nipple assembly sealingly and removably affixed to the open end of the bottle. The bottle contains a liquid suitable for consumption by an infant. The bottle is filled to no more than 80 percent of capacity. The nipple assembly is threaded onto the bottle. However, the disposable infant beverage container disclosed in Fialkowski; Edward B. reference is having a complex structure that requires significant use of plastic to construct, is susceptible to spillage during operation, and has a fixed capacity for the beverage storage.

U.S. Pat. No. 6,138,847 A filed by Johnson discloses a disposable non-reusable baby bottle which serves as both shipping container and feeding system for ready-to-use liquids. The disposable non-reusable baby bottle disclosed in Johnson reference provides a generally cylindrical container having an opening at one end, a nipple, and a snap ring which locks the nipple to the open end of the container. However, disposable non-reusable baby bottle disclosed in Johnson reference is having a predefined structure and may have bulky components and complex processes to consume the stored beverage.

This specification recognizes that the beverage container should be safe and simple to use, lighter, portable, and disposable, while minimizing construction material. Preparing, storing, and serving liquid food or beverages in the most convenient way that shall free the caregivers or users from washing and sterilizing containers is the main focus of the present specification.

### SUMMARY

The present invention provides a disposable liquid container with an integral specialized dispensing nozzle. The disposable container includes a body portion, a sealing collar, a nozzle, and a sealing disc. A threaded neck is integral to or attached to the body portion. The body portion is made of a laminated material. The sealing collar is adapted to be detachably attached with the body portion. The nozzle is removably fixed to the body portion with the sealing collar adapted to be screwed on to the threaded neck. The sealing disc disposed between the sealing collar and the nozzle to stop the flow of a liquid to the nozzle. The disposable container includes a lid to screw into the threaded neck of the body portion.

In an embodiment, the lid is semi-permanently attached to the body portion or the threaded neck.

In an embodiment, the laminated material may be a laminated moisture-resistant packaging material such as paperboard, similar to Tetrapak® or other commercially available products used for packaging beverages or liquid food product. Typically, such laminate is a foil, paper, and plastic laminate, with paper being predominate structural material, plastic to provide sealing qualities, and foil to prevent oxidation and light penetration. In alternative embodiments, the laminate may be some other laminate adapted for liquid containment and preservation. In an embodiment, the laminated material comprises three layers of polyethylene, a layer of aluminium foil, and a layer of paperboard.

Laminated fluid storage containers are highly beneficial in a variety of aspects. Namely, such containers significantly reduce the intensity of materials required for construction. Additionally, they are highly portable as they exhibit significant flexibility, even when filled. The flexibility of such a container allows a consumer to apply pressure in a way that urges fluid out of the container, and allows a consumer to dispense the fluid in this manner in a relatively continuous manner, wherein a large portion of the containers contents can be dispensed in a continuous action. Furthermore, a given flexible laminated container can contain varying capacities without the need for modifying the container or partially filling the container with air.

In an embodiment, the nozzle is selected from at least one of a baby-feeding nipple, a snap-type cap, and a micro nozzle.

In an embodiment, the beverage is milk, juice, sports drink, saline, or any other liquid that must be stored sterile and must be dispensed through a specialized dispensing nozzle.

In an embodiment, the nozzle comprises a drinking hole to facilitate a user to consume the beverage.

In an embodiment, the sealing disc is made of a food-grade plastic.

In an embodiment, the baby-feeding nipple is made of at least one of an elastomer, a semi-rigid thermoplastic polymer, a plastic, latex or silicone.

In an embodiment, the body portion is pre-filled with the beverage.

In an embodiment, the disposable infant beverage container includes a positioning element operable to position the baby-feeding nipple inward facing and outward facing.

In an embodiment, the sealing disc is attached to the threaded neck to prevent tampering and provide freshness to the beverage pre-filled in the body portion.

In an embodiment, the disposable infant beverage container is having a plurality of styles selected from at least one of a pouch, a “sachet-style”, a Tetrapak® style.

The disclosed embodiments provide a number of distinct advantages over the prior art. One advantage of the present invention is that it allows a direct dispensation or consumption of the beverages from the disposable beverage container via the nozzle. Another advantage of the present invention is that it provides the disposable infant beverage container with the pre-filled beverage which is convenient for the users. Another advantage of the present invention is that it is utilized by the user in a filled state so that he/she can easily carry with them. Another advantage of the present invention is that it provides a sanitary seal as well as a specialized nozzle. Another advantage of the present invention is that it may be constructed with minimal material intensity. Another advantage of the present invention is that the container is adapted to allow a user to apply continuous dispensing pressure. Another advantage of the present invention is that it may be distributed in a configuration that inherently protects the nozzle from damage or contamination. Another advantage of the present invention is that it can be utilized for various applications such as a baby feeding bottle, sterile fluid dispensation, sports drink dispensation for adults, etc.

Accordingly, another advantage of the present invention is that the nozzle may be a plastic spray nozzle which can be used to apply a stream of liquid in a variety of applications such as washing wounds in hospital setting, sharing a drink where direct contact with the nozzle is not desirable, or in sports where equipment such as helmet or mouth guard makes sucking difficult and spraying a stream desirable. Examples of the nozzle include but not limited to a micro nozzle, and a snap type cap.

Other features of embodiments of the present invention will be apparent from accompanying drawings and from the detailed description that follows.

Other objects and advantages of the present invention will become readily apparent to those skilled in the art following the detailed description, wherein the preferred embodiments of the invention are shown and described, simply by way of illustration of the best mode contemplated herein for carrying out the invention. As is recognized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an exploded view of a disposable container, in accordance with one embodiment of the present invention.

FIG. 2 illustrates an assembled view of the disposable container, in accordance with one embodiment of the present invention.

FIG. 3 illustrates a micro nozzle, in accordance with one embodiment of the present invention.

FIG. 4 illustrates the snap type cap, in accordance with one embodiment of the present invention.

FIG. 5 illustrates an exemplary view of the sachet-style disposable container, in accordance with one embodiment of the present invention.

FIG. 6 illustrates an exemplary view of the Tetrapak® style disposable infant container, in accordance with one embodiment of the present invention.

### DETAILED DESCRIPTION

The present invention is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

The disposable container is disclosed to facilitate efficient and comfortable consumption of various beverages such as milk or water or application of various fluids such as saline or cleansing fluid. Embodiments of the present invention include various steps, which will be described below. Although the present invention has been described with the purpose of disposable container, it should be appreciated that the same has been done merely to illustrate the invention in an exemplary manner and to highlight any other purpose or function for which explained structures or configurations could be used and is covered within the scope of the present invention.

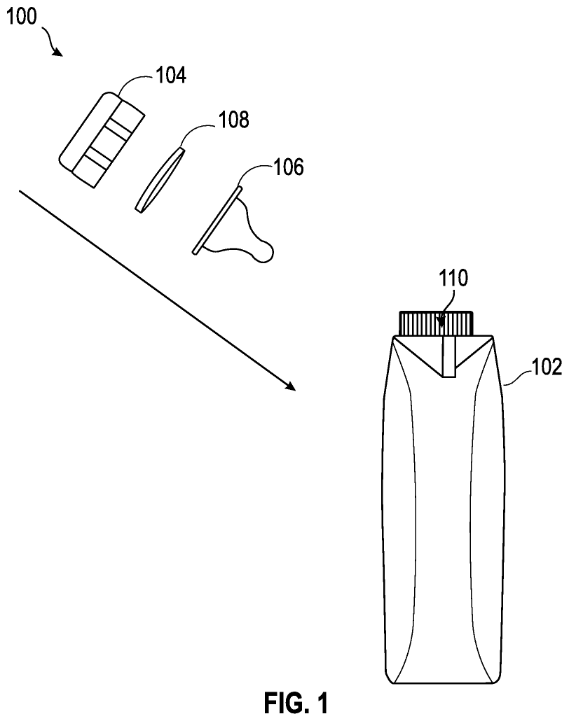

FIG. 1 illustrates an exploded view 100 of a disposable container, in accordance with one embodiment of the present invention. The disposable container 100 includes a body portion 102, a sealing collar 104, a nozzle 106, and a sealing disc 108. The body portion 102 has a threaded neck 110 formed from the body portion 102. In an embodiment, the body portion 102 is made of a laminated material. In an embodiment, the laminated material comprises a plastic material and a metallic layer. In an embodiment, the laminated material of the body portion 102 is a laminated moisture-resistant packaging material for packaging a liquid food product. Example of the laminated moisture-resistant packaging material includes but not limited to Tetrapak®.

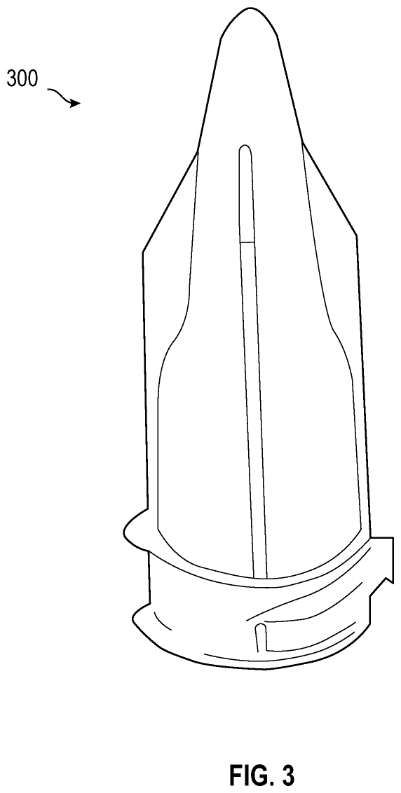

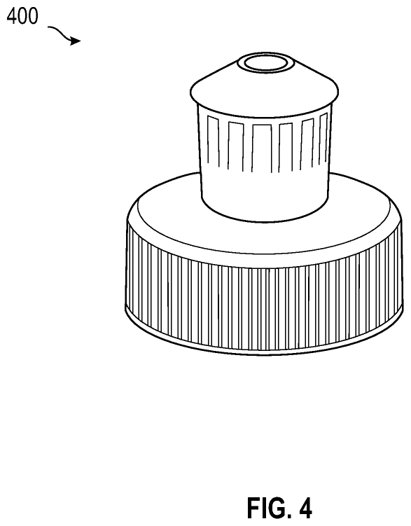

The sealing collar 104 is adapted to detachably attached with the body portion 102. The nozzle 106 is removably fixed to the body portion 102 with the sealing collar 104 adapted to be screwed on to the threaded neck 110. In an embodiment, the nozzle 106 is selected from at least one of a baby-feeding nipple, a snap type cap 300 (shown in FIG. 3), and a micro nozzle 400 (shown in FIG. 4). In an embodiment, the nozzle 106 comprises a drinking hole to facilitate a user such as an infant, or adult to consume the beverage. In an embodiment, the nozzle 106 may have a small hole for liquid or x type hole for soft solids consumption.

Typically, the baby-feeding nipple has a mouth portion made of elastomer, latex, silicone, or other similarly flexible material and a base portion made of semi-rigid thermoplastic polymer. The drinking hole may be constructed as a circular hole or as a slot. In an embodiment, the baby-feeding nipple is made of at least one of an elastomer, a semi-rigid thermoplastic polymer, a plastic, a latex, or silicone. For sanitary and sealing reasons other plastic coverings or seals may also be utilized by the present disposable beverage container.

In an embodiment, the nozzle 106 may be substituted for snap type plastic nipple for adult applications. In an exemplary embodiment, a plastic conical micro nozzle can also be used as the nozzle 106 for applying products to surfaces.

The sealing disc 108 disposed between the sealing collar 104 and the nozzle 106 to stop the flow of a beverage to the nozzle 106. In an embodiment, the sealing disc 108 is made of a food grade plastic. The sealing disc 108 is attached to the threaded neck 110 to prevent tampering and provide freshness to the beverage pre-filled in the body portion 102.

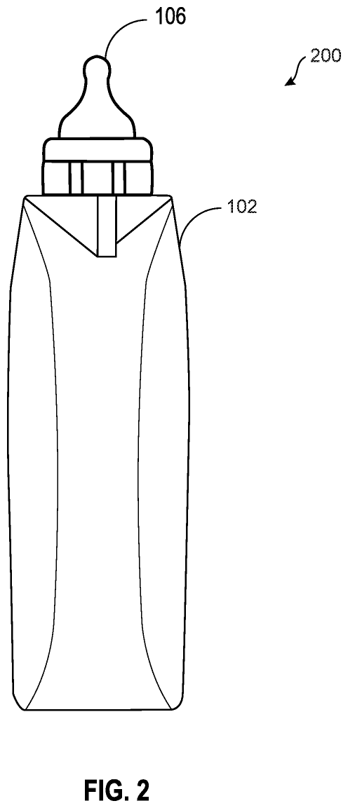

FIG. 2 illustrates an assembled view of the disposable beverage container 200, in accordance with one embodiment of the present invention. FIG. 2 is explained in conjunction with FIG. 1. The disposable infant beverage container 200 includes a lid to screw into the threaded neck 110 of the body portion 102. The lid is semi-permanently attached to the body portion or the threaded neck.

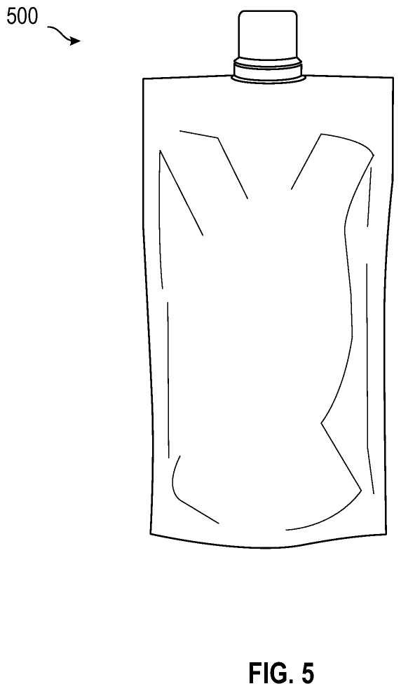

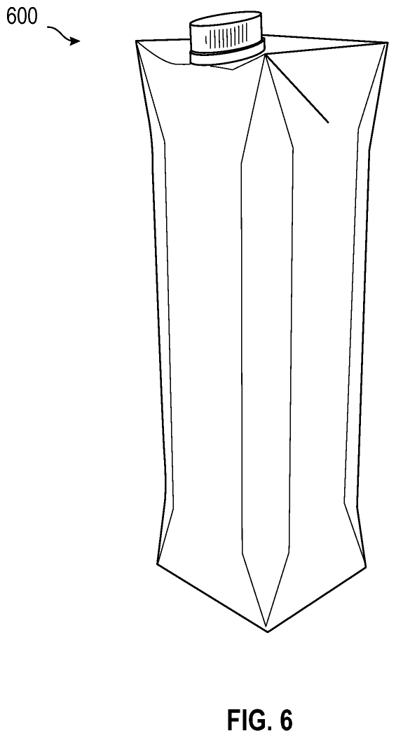

The lid may allow the user to remove the nozzle 106 from the disposable beverage container 200 and cover the remaining beverage, after a feed, with the lid. The solid lid won't allow any leakage. The disposable infant beverage container 200 may include a positioning element operable to position the baby-feeding nipple inward facing and outward facing. In an embodiment, the disposable infant beverage container 200 is having a plurality of styles selected from at least one of a sachet-style 500 (shown in FIG. 5), a Tetrapak® style 600 (shown in FIG. 6).

The invention is designed to be distributed with the nozzle diposed inwardly, and the nozzle 106 is adaptable to flip through the sealing collar 104 to face outward, and further adaptable to re-tighten the sealing collar 104 and the nozzle 106 in place by screwing back down. In an embodiment, the body portion 102 is pre-filled with the beverage. Examples of the beverage include but not limited to milk, juice, sports drink, protein drink, saline, or any other liquid that must be stored sterile and must be dispensed through the nozzle such as a cleaning solution.

In alternative embodiments, the body portion of the container may be constructed in a manner to dispose the threaded neck at an angle other than parallel to the container's primary axis. For example, in an embodiment, it may be beneficial for the threaded neck and nozzle assembly be disposed at a slight or significant angle in order to improve dispensation of the contained fluid.

In operation, the sealing collar is opened and a safety seal is broken to remove the nipple and sealing disc. The user may discard or store the sealing disc for later use. Further, the user may flip the nipple through the sealing collar to face outward and re-tighten the sealing collar and nipple in place by screwing back down. Thus the present disposable beverage container and method to provide an efficient, and simpler allow a direct consumption of the beverages from the disposable beverage container via the nipple.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

1. A disposable fluid container, comprising:
a body portion having a threaded neck, wherein the body portion is made of a laminated material, wherein the laminated material comprises of three layers of polyethylene, aluminium foil, and paperboard, and wherein the polyethylene is used to provide sealing qualities, the aluminium foil is used to prevent oxidation and light penetration, and the paperboard is used as a predominant structural material;
a sealing collar adapted to be detachably attached with the body portion;
a nozzle removably fixed to the body portion with the sealing collar adapted to be screwed onto the threaded neck,
wherein the nozzle is adapted to being disposed both inwardly and outwardly; and
a sealing disc disposed between the sealing collar and the nozzle to stop flow of a beverage to the nozzle, wherein the disposed sealing disc is removed by a user to use the container for drinking the beverage, and wherein the removed sealing disc is further used by the user for disposing between the sealing collar and the nozzle to stop the flow of the beverage.

2. (canceled)

3. (Canceled)

4. (canceled)

5. The disposable fluid container as claimed in claim 1, wherein the nozzle is selected from at least one of a baby-feeding nipple, a snap type cap, and a micro nozzle.

6. The disposable fluid container as claimed in claim 5, wherein the baby-feeding nipple is made of at least one of an elastomer, a semi-rigid thermoplastic polymer, a plastic, latex, silicone and a combination thereof.

7. The disposable fluid container as claimed in claim 5, wherein the body portion is pre-filled with a fluid.

8. The disposable fluid container as claimed in claim 7, wherein the fluid is a baby formula.

9. The disposable fluid container as claimed in claim 7, wherein the fluid is a cleansing solution.

10. The disposable fluid container as claimed in claim 1, wherein the beverage is selected from at least one of milk, juice, sports drink, saline, and soft drink.

11. The disposable fluid container as claimed in claim 1, wherein the nozzle comprises a drinking hole to facilitate the user to consume the beverage.

12. The disposable fluid container as claimed in claim 1, wherein the sealing disc is attached to the threaded neck to prevent tampering and provide freshness to the beverage pre-filled in the body portion.

13. The disposable fluid container as claimed in claim 1, wherein the sealing disc is made of a food-grade plastic.

14. The disposable fluid container as claimed in claim 12, wherein the threaded neck is disposed at an angle other than parallel to the container's primary axis.
